(19) United States
(12) Patent Application Publication
(10) Pub. No.: US 2012/0175817 A1
(43) Pub. Date: Jul. 12, 2012

(54) HYDROLYTICALLY STABLE POLYAMIDE

(75) Inventors: Bettina Becker, Monheim (DE); Siegfried Kopannia, Krefeld (DE); Tina Nataniel, St. Charles, IL (US); Fabio Ticozzelli, Pasturo-Lecco (IT); Dwight Heinrich, Aurora, IL (US); Luca Marchese, I-Arese (Mi) (IT)

(73) Assignee: Henkel AG & Co. KGaa, Duesseldorf (DE)

(21) Appl. No.: 13/423,670

(22) Filed: Mar. 19, 2012

Related U.S. Application Data
(63) Continuation of application No. PCT/EP2010/062621, filed on Aug. 30, 2010.

(30) Foreign Application Priority Data
Sep. 18, 2009 (EP) 09170635.8

(51) Int. Cl. B29C 45/00

(52) U.S. Cl. 264/328.1

(57) ABSTRACT

The invention relates to the use of polyamides on the basis of reaction products from at least one dimeric fatty acid, at least one aliphatic dicarboxylic acid having 6 to 24 C atoms and aliphatic, cycloaliphatic and/or polyether diamines, wherein the quantities of amine components are selected so that primarily terminal amine groups are contained therein, and the polyamide comprises an amine count from 2 to 20 mg KOH/g to produce molded parts in the low pressure injection molding method.

The invention relates to polyamides which are used for injection molding processes. These must have a suitable viscosity and should display improved stability towards hydrolysis.

EP 0749463 describes polyamide hot melt adhesives which contain polyamides based on dimerized fatty acid as well as calcium carbonates as filler. The polyamides of the hot melt adhesive only contain less than 50% proportions of dimer fatty acids. As an additional component, polyether diamines and aliphatic diamines with 2 to 40 C atoms are used. Polyamides with amine end groups are described. The hot melt adhesives are described for the conventional adhesive applications.

Molded parts based on polyamides are also known, for example. EP 1 533 331 describes polyamides based on C₁₈-C₂₄ dimer fatty acids as a molding composition for the production of molded parts for producing electronic components by an injection molding process, wherein these additionally contain dimer diamines. As a use, it is described that other molded parts, such as cables, cable connectors, contact sleeves etc., can be encapsulated in these liquid hot melt adhesive molded parts, thus providing a firm mechanical bond. In the described embodiments, dimer fatty amines with 24 to 48 C atoms are used as the amine component.

EP 0965627 describes polyamide hot melt adhesives, which are constituted on the basis of polymer fatty acids and aliphatic dicarboxylic acids. Products with equal COOH/amine equivalents are used, or alternatively carboxyl groups are used in a slight excess. As applications, the known adhesive applications of hot melt adhesives are described.

The known polyamide hot melt adhesives can, on the one hand, be used as typical hot melt adhesives. In this case, it is useful for these to have a low viscosity and a sufficient open assembly time in which the molten adhesives can bond the substrates. High adhesion to the substrate is necessary here and there should be a firm bond between the substrates.

If molded parts based on polyamides are used, the properties are often selected so that good mechanical stability and flexibility of the polymers are obtained. These should remain permanently flexible, but also form an object that is dimensionally stable at elevated temperatures. This behavior is in contrast to properties for producing such parts, because in this case a low application viscosity and a relatively low softening point are useful. For an application as a molded part, the mechanical stability should be good even at elevated temperatures. For this reason, it is advantageous if high melting and softening points are selected.

In the case of the permanent loading of polyamide molded parts, it has been shown that they have only a limited degree of stability towards hydrolysis. This is expressed by the fact that, as a result of relatively high exposure to humidity and additionally to heat, the mechanical properties of the molded parts change and properties such as strain behavior and modulus become lower. Thus, the mechanical stability of these molded parts overall is negatively affected and can lead to failure of the components.

The object of the present invention is therefore to provide polyamides that are suitable for use as a molded part in the injection molding process. These should have a low viscosity at the processing temperature and at the same time the softening point should be sufficiently high for no mechanical overloading of the molded part to occur under service conditions. Furthermore, these mechanical properties should be maintained even with prolonged exposure to water and to elevated temperature.

The object is achieved by the use of polyamides based on reaction products of at least one dimer fatty acid, at least one aliphatic dicarboxylic acid having 6 to 24 C atoms and aliphatic, cycloaliphatic and/or polyether diamines, wherein the quantities of the amine component are selected such that predominantly amine end groups are contained and the polyamide has an amine value of 2 to 20 mg KOH/g, for the production of molded parts in a low-pressure injection molding process.

The polyamides that are suitable according to the invention should exhibit reduced absorption of water. This can be achieved by the selection and quantity of the amine and carboxylic acid components. Furthermore, it should be ensured that a low processing viscosity is maintained at the same time as a high softening point of the polyamides.

According to the invention, for this application it is possible to use polyamides that are made up of the following components:
50 to 98 mole % dimer or polymer fatty acid,
2 to 50 mole % C₆ to C₂₄ aliphatic or cycloaliphatic dicarboxylic acid,
0 to 10 mole % C₁₂ to C₁₈ monocarboxylic acids,
wherein the sum should add up to 100 mole %, and
100 to 60 mole % aliphatic and/or cycloaliphatic diamines,
0 to 40 mole % polyoxyalkylene diamines,
wherein the sum should also add up to 100 mole %. There should be a slight excess of amino equivalent over carboxyl equivalent here.

Dimer or polymer fatty acids within the meaning of this invention are those fatty acids that can be obtained in a known manner by dimerization of from natural raw materials. These are produced from unsaturated long-chain fatty acids and then purified by distillation. As technical dimer fatty acid, depending on the degree of purity, less than 5% monobasic fatty acids are contained, substantially C₁₈ fatty acids such as linolenic acid or oleic acid, up to 98 wt. % C₃₆ dibasic fatty acids (dimer fatty acids in the narrower sense) and also small proportions of higher polybasic fatty acids (“trimer acids”). The relative ratios of the monomer, dimer and trimer fatty acids in the polymer fatty acid mixture depend on the nature of the starting compounds used and the polymerization, dimerization or oligomerization conditions and the degree of distillative separation. Dimer fatty acids purified by distillation contain up to 98 wt. % of dimer fatty acid. In another processing step, these dimer fatty acids can also be hydrogenated. These hydrogenated dimer fatty acids can also be used according to the invention.

In addition to the dimer fatty acids, the acid component of the polyamide should also contain C₆ to C₂₄ dicarboxylic acids. Examples of these dicarboxylic acids are succinic acid, adipic acid, azelaic acid, sebacic acid, undecanedioic acid, dodecanedioic acid, glutaric acid, suberic acid or pimelic acid. Proportions of aromatic dicarboxylic acids, such as e.g. terephthalic acid, isophthalic acid or mixtures of the aforementioned dicarboxylic acids, can also be used in the synthesis reaction. Preferably, however, longer-chain aliphatic dicarboxylic acids, for example from C₁₀ to C₁₈, are selected; in this case, water absorption by the resulting polyamide can be reduced.

It is likewise possible to add proportions of long-chain aminocarboxylic acids having 10 to 18 C atoms, such as 11-aminoundecanoic acid or also lauryl lactam, instead of the dicarboxylic acids.

The diamine component substantially consists of one or more aliphatic diamines, wherein the amino groups are at the ends of the carbon chains. The aliphatic diamines can contain 2 to 20 carbon atoms, with the aliphatic chain being linear or branched. Examples are ethylenediamine, diethylenetriamine, dipropylenetriamine, 1,4-diaminobutane, 1,3-pentanediamine, methylpentane diamine, hexamethylenediamine, trimethyl hexamethylenediamine, 2-(2-aminomethoxy)ethanol, 2-methyl pentamethylenediamine, C₁₁ neopentane diamine, diaminodipropylmethylamine or 1,12-diaminododecane. Particularly preferred primary alkylene diamines are C₂-C₁₂ diamines with an even number of carbon atoms.

The amino component can also contain cyclic diamines or heterocyclic diamines, such as e.g. 1,4-cyclohexanediamine, 4,4′-diaminodicyclohexylmethane, piperazine, cyclohexanebis(methylamine), isophorone diamine, dimethylpiperazine, dipiperidyl propane, norbornanediamine or m-xylylenediamine. A particular embodiment uses a mixture of alkylene diamines and cyclic diamines.

If the polyaminoamide should exhibit higher flexibility, polyoxyalkylene diamines, such as e.g. polyoxyethylene diamines, polyoxypropylene diamines or polytetrahydrofuran diamines, can additionally be used. The polyoxyalkylene diamines having a molecular weight of between 150 and 4000 g/mol, preferably between 300 and 3000 g/mol (number average, M_{N}), are preferred here. As amine components in the polyamides that are suitable according to the invention, polyether polyols with primary amino end groups are preferably suitable, in particular those that are not, or are only slightly, water-soluble, examples of these being those based on polytetrahydrofurans or polypropylene oxides.

When selecting the monofunctional, difunctional or trifunctional raw materials to be used, it should be ensured that fusible, i.e. non-crosslinked, products are obtained. For example, suitable polyamides can be obtained when crosslinkages or gelations occur by reducing the proportion of trifunctional components (trimer fatty acids) and/or increasing the content of monofunctional amines or fatty acids. Through the formation of linear polyamides, a lower viscosity is also obtained.

In general, the quantities of amines and carboxylic acids are selected such that the polyamides have an amine content of between 2 and 20 mg KOH/g (DIN 53176), and in particular the amine value should be between 2 and 10. Through the selection of the short-chain diamines and the aliphatic dicarboxylic acids, and the purity of the dimer fatty acid, both the viscosity and viscosity-temperature profile and the softening point of the hot melt adhesive can be adjusted so that the hot melt adhesive is suitable for the use according to the invention. The molecular weight (measured as weight average molecular weight, M_{w}, as obtainable by GPC) can be between 10000 and 200000 g/mol, in particular between 20000 and 120000 g/mol. The acid value of the polyamide is low, usually less than 2 mg KOH/g and in particular less than 1 mg KOH/g.

The corresponding polyamide compositions should be pumpable in the molten state and capable of being injected in the low-pressure injection molding process. The viscosity of the suitable polyamides should be between 300 and 100000 mPas (measured in the range of 180 to 240° C., ASTM D3236), preferably up to 50000 mPas and in particular from 500 to 5000 mPas. The softening point of a suitable polyamide should be greater than 120° C. (“Ring and Ball” method ASTM E 28), in particular over 150° C. up to 250° C.

A preferably suitable embodiment for use according to the invention uses polyamides made from carboxylic acids, consisting of
50 to 75 mole % dimer fatty acids,
25 to 50 mole % aliphatic or cycloaliphatic dicarboxylic acid having 6 to 24 C atoms, in particular C₁₀ to C₁₈,
0 to 10 mole % monocarboxylic acids,
wherein the sum should add up to 100 mole %.

Another embodiment uses amines as a mixture, in particular 70 to 98 mole % aliphatic and/or cycloaliphatic diamines, preferably as a mixture of aliphatic and cycloaliphatic diamines, in particular with 2 to 12 C atoms, and 2 to 30 mole % polyoxyalkylene diamines based on p-tetrahydrofuran or polypropylene glycol, wherein the sum should also add up to 100 mole %.

Overall, the dicarboxylic acids are used preferably in up to a 10% substoichiometric quantity compared with the diamines, so that amino-terminated polyamides are formed.

An essential feature of the polyamides that are suitable according to the invention is their hydrolysis resistance. By means of the selection of the components for reduced water absorption, the resistance to water/humidity is increased. According to the invention, the stability should be selected so that the tensile strength of a sample is reduced by less than 20% by exposure to water and subsequent drying. As a test, a test piece is stored for 1000 h at 85% relative humidity at a temperature of 85° C. The test piece is then dried again to a water content of approx. 0.05%. The mechanical values are determined beforehand and afterwards. The polyamides according to the invention are thus suitable as stable moldings under wet or humid application conditions.

Methods of producing polyamides are known. In these methods, the raw materials are melted and dried and reacted together at elevated temperatures. Water of reaction that forms is removed from the mixture. Once the suitable molecular weight has been obtained, the polymer is filled and cooled. The polymer can be filled in the form of blocks, rods and pellets. However, the other additives can also be added immediately after the polymer synthesis.

From the polyamides that are suitable according to the invention, together with conventional additives, fusible molding compositions can be obtained. For example, plasticizers, adhesion promoters, stabilizers, antifoam agents, flow control agents or fillers can additionally be contained. Plasticizers increase the plasticity of the compositions; for example, polar plasticizers such as esters, long-chain amines and sulfonic esters can be used. It should be ensured in this case that they do not affect the stability of the polymer chains. Furthermore, fillers may optionally be used in minor quantities, e.g. silicates, talc, calcium carbonates, clays, carbon black or pigment pastes/pigments. In particular, however, the molding compositions contain only small proportions, less than 5 wt. %, of pigments or fillers, and in particular they are free from fillers.

Depending on the intended application, it may be appropriate to stabilize the composition. As antioxidants, in particular the antioxidants of the sterically hindered phenols or aromatic amine derivatives type are suitable here in quantities of up to 2.5 wt. %, based on the polymer. Products of this type are known to the person skilled in the art. As molding compositions for melting, the compositions are free from solvents.

From the fusible polyamides, compositions for use as a molding composition can be produced by known methods. This can be achieved by adding the above-mentioned additives and auxiliary substances in the melt. The components can also be homogenized continuously by mixing in an extruder. This can take place immediately after production, but it is also possible for specific compositions to be mixed only immediately before processing.

For the use according to the invention, the molding compositions are melted and then used in the low-pressure injection molding process.

From these molding compositions, molded parts can be produced by known processing methods, for example by extrusion, casting, injection molding, compression molding, transfer molding, etc. However, according to the invention the molding composition is processed into molded parts by low-pressure injection molding. This injection molding cycle comprises the following individual steps:
a) The mold is closed after any parts to be bonded have been inserted.
b) The molten molding composition is injected into the mold up to a pressure of between 0.5 and 50 bar and optionally subjected to holding pressure.
c) The molding composition is left to solidify by cooling.
d) The mold is opened.
e) The injection-molded parts are removed from the mold.

The low-pressure injection molding method generally operates in the range of 2 to 40 bar, the temperature being between 160 and 250° C.

The polyamide compositions that can be used according to the invention as a molding composition are distinguished by high mechanical stability. At the same time, the compositions are elastic. Furthermore, they are distinguished by high mechanical strength, i.e. they are dimensionally stable in the shape originally produced.

The polyamides according to the invention in the molding compositions are distinguished in particular by high stability towards humidity. Those molded parts that can be produced by the use according to the invention are often exposed to the environment, for example in the open air or in the ground. They are exposed to high levels of humidity and to changing temperatures there. The humidity can be up to 100% and the temperatures are within the conventional temperature range, for example between −10° C. and +90° C. Under these conditions, it has been shown that the polyamides that can be used according to the invention have high stability. Even under the prolonged influence of humidity and elevated temperatures, no water degradation of the polyamide chain is observed. It is known that molded parts under these conditions absorb a small quantity of water, leading to a change in mechanical properties. This change becomes apparent as a loss of mechanical stability. Even after removing the absorbed water, the initial strength is not reached. When the molding compositions according to the invention are used, it can be observed that after drying and removal of the absorbed water, only a small decrease in mechanical strength or elongation at break can be observed. The compositions or the molded parts made from the compositions have the same mechanical strengths as before exposure to water.

Through the use of the polyamides that are suitable according to the invention as molding compositions, moldings having high stability towards environmental conditions are obtained. As a result of the low viscosity of the polyamides, it is possible to use these in a low-pressure injection molding process. In this case the requirements for the processing equipment are lower and the processing times are shorter. This leads to rapid processing and production cycles, and cost-effective production of molded parts is possible.

### EXAMPLE 1

From 62.46 mole % dimer fatty acid, 37.54 mole % sebacic acid, 10.23 mole % Jeffamine D 2000, 48.98 mole % piperazine and 40.79 mole % ethylenediamine, by a method that is known per se, a polyamide is produced by a condensation reaction with removal of the water of reaction.

Characteristic values: amine value: 6 mg KOH/g, melt viscosity: 4000 mPa·s at 210° C., softening point: 160° C.

### COMPARATIVE EXAMPLE 2

In the same way, from 62.10 mole % dimer fatty acid, 37.90 mole % sebacic acid, 9.54 mole % Jeffamine D 2000, 50.95 mole % piperazine and 39.51 mole % ethylenediamine, by a method that is known per se, a polyamide is produced by a condensation reaction with removal of the water of reaction.

Characteristic values: acid value: 6 mg KOH/g, melt viscosity: 4000 Pa·s at 210° C., softening point: 150° C.

From the polyamides according to Examples 1 and 2, a test piece was produced in the form of a dumbbell, and elongation at break, tensile strength and viscosity were measured.

Corresponding test pieces were then stored at 85° C. and 85% relative humidity. After 1000 h, the mechanical values were determined again.

| | Example 1 | Comparison 2 |
|---|---|---|
| Tensile strength [N/mm²] | 3.5 | 2.8 |
| Elongation at break [%] | 440 | 410 |
| M_{w} (molecular weight) | 43,000 | 41,000 |
| 1000 h storage (wet) | | |
| Tensile strength | 2.6 | 1.0 |
| Elongation at break | 260 | 40 |
| 1000 h (dried) | | |
| Tensile strength | 3.5 | 1.8 |
| Elongation at break | 340 | 50 |
| M_{w} | 42,000 | 20,000 |

Tensile strength/elongation at break were determined in accordance with DIN ISO 527.

After drying and removal of the absorbed water, the mechanical stability has remained almost the same. No polymer degradation has apparently taken place. The comparative test shows degradation of the polyamides.

What is claimed is:

1. Use of polyamides based on reaction products of at least one dimer fatty acid, at least one aliphatic dicarboxylic acid having 6 to 24 C atoms and aliphatic, cycloaliphatic and/or polyether diamines, wherein the quantities of the amine component are selected such that amine groups are predominantly contained in the end positions and the polyamide has an amine value of 2 to 20 mg KOH/g, for the production of molded parts in a low-pressure injection molding process.

2. The use according to claim 1, wherein the polyamide contains 50 to 98 mole % dimer fatty acids, 50 to 2 mole % C₆ to C₂₄ aliphatic dicarboxylic acids, 0 to 10 mole % of a C₁₄ to C₂₂ monocarboxylic acid, 0 to 40 mole % polyether diamines and 100 to 60 mole % aliphatic diamines.

3. The use according to claim 1, wherein the amine component consists of a mixture of aliphatic and cycloaliphatic diamines.

4. The use according to claim 1, wherein C₂ to C₂₀ diamines are used as the aliphatic amine.

5. The use according to claim 3, wherein the polyamide contains at least 2 mole % polyether amines in particular based on polypropyl glycol and/or p-tetrahydrofuran.

6. The use according to claim 1, wherein the weight average molecular weight (M_{w}) of the polyamide is 10000 to 200000 g/mol, in particular from 20000 to 120000 g/mol.

7. The use according to claim 1, wherein the melt viscosity is 300 to 50000 mPas measured at 180 to 240° C.

8. The use according to claim 7, wherein the polyamide has a softening point of over 150° C.

9. The use according to claim 1, wherein the polyamide is hydrolytically stable on exposure to water.

10. The use according to claim 9, wherein the tensile strength changes by less than 20% before and after exposure to water.

11. The use according to claim 1, wherein the composition consists of polyamides and, as additional components, pigments, stabilizers and antioxidants, in particular less than 5 wt. % pigments.

12. The use of polyamides according to claim 1 optionally together with inserts in a low-pressure injection molding process.
